(19) United States
(12) Patent Application Publication
(10) Pub. No.: US 2026/0257837 A1
(43) Pub. Date: Sep. 3, 2026

(54) CONTAINER DIVIDER APPARATUS AND METHOD THEREOF

(71) Applicant: Buyers Products Company, Mentor, OH (US)

(72) Inventor: Vince Scotese, Jefferson, OH (US)

(21) Appl. No.: 19/067,423

(22) Filed: Feb. 28, 2025

(51) Int. Cl. B65D 25/06; B60R 9/06

(52) U.S. Cl. CPC B65D 25/06; B60R 9/065

(57) ABSTRACT

Provided in this disclosure is an article and method for dividing a container, such as a toolbox, used with vehicles, such as pickup trucks, to prevent rattling caused by loose dividers. The divider is one piece and has tapered sections to allow for easier installation when a container includes lips that extend beyond the interior walls of the container. The divider also has a section with variable thickness with some tension to permit the divider to rest firmly in a slot or slots in the container to prevent rattling.

### I. BACKGROUND

### A. Technical Field

This invention pertains to the field of dividers for containers. More particularly, the present invention relates to dividers that are easy to install and do not rattle in toolboxes for vehicles.

### B. Description of Related Art

Individuals who work with tools and who need to be mobile often move their tools via toolboxes in vehicles such as pickup trucks. When driving over rough terrain, which can include potholes on paved streets, individuals desire their tools to remain organized. To keep tools organized, individuals may use dividers in their toolboxes. This presents at least two problems. First, dividers can be difficult to install. Second, dividers rattle loudly against the toolbox causing a distraction and hazard to an individual driving the vehicle.

While various types of dividers and containers exist, the toolbox industry is more focused on function over ease of use or comfort for the user and existing dividers have one thickness throughout instead of providing a hinged thickness. The present invention is designed to make installation simpler and more comfortable to users by removing rattling.

### II. SUMMARY

The present invention relates generally to dividers for containers and methods for assembling containers with dividers. Such are configured to, for example, allow a skilled artisan to create dividers that are easy to install and do not rattle.

According to an aspect of the invention, one embodiment of this invention includes a first divider that is one piece and a container that has a first slot in its walls. The first divider includes a section that has been folded behind the first divider at the top of the first divider making the top of the first divider thicker than the rest of the first divider. This piece acts as a hinge with a small adjustable gap between the front and back of the first divider. The thicker top of the hinge can be inserted into one or more slots. As the top enters the slot, the two sides of the folded piece get closer together. When the first divider is fully in the slot, the folded piece expands again, firmly locking the first divider into place. This first divider creates a separate compartment within the larger container. Multiple dividers may be placed within the same container to create multiple compartments of the larger container. In some examples, the piece that is folded behind the first divider is the same length as another section of the first divider. In other examples, the piece that is folded behind the first divider is a different length from another section of the first divider.

According to another aspect of the invention, one embodiment of this invention includes a first divider that is one piece of metal. The first divider includes a section that has been folded behind the first divider at the top of the first divider creating a hook behind the first divider. This hook can be used to firmly lock the first divider into place, creating a separate compartment within the larger container. Multiple dividers can be placed within the same container to create multiple compartments of the larger container.

In some examples, the container can have four walls with multiple slots. In other examples, the container could have four walls with one slot. In still other examples, the container could have two walls with one slot or multiple slots. In yet other examples, the container could have three walls with one slot or multiple slots.

In some examples, the depth of the container is the same height as the first divider. In other examples, the first divider is greater in height than the depth of the container. In still other examples, the length of the first divider is the same as the width of the inside of the container. In yet other examples, the length of the first divider is less than the width of the inside of the container.

In some examples, the container and first divider are made of the same singular rigid material. The rigid material can be metal, steel, stainless steel, aluminum, cardboard, plastic, wood, and other materials. In other examples, the container and first divider are made of different singular materials. In still other examples, the container is made of multiple different materials, and the first divider is made of a singular material. In yet other examples, the container is made of a singular material the first divider is made of multiple different materials. In further other examples, both the container and first divider are made up of multiple different materials.

In some examples, the container has the same inside width throughout the entirety of the container. In other examples, the top portion of the container has a lesser inside width than the remainder of the container. In still other examples, the inside width of the container varies throughout the depth of the container. In yet other examples, the middle portion of the inside of the container has a greater inside width than the remainder of the container.

In some examples, a first slot is in any of the outer walls of the container. In still other examples, a first slot is in the inner walls of the container. In yet other examples, a first slot is partially in any outer walls and partially in any inner walls of the container. In still other examples, a first slot is less high than the entire height of any inner wall of the container. In yet other examples, a first slot is less high than the entire height of any outer wall of the container. In still other examples, a first slot is the same height as any outer or inner wall of the container.

In some examples, the first divider has lengths that vary. In some examples, the length of the top of the first divider is less than the length of the bottom of the first divider. In some examples, the length of the top of the first divider is the same as the length of the bottom of the first divider. In yet other examples, the length of the top of the first divider is greater than the length of the bottom of the first divider.

In some examples, the middle of the first divider has a different length than the top and bottom of the first divider. In other examples, the middle of the first divider has a smaller length than the top and bottom of the first divider. In yet other examples, the middle of the first divider is the same length as the top of the first divider but smaller than the length of the bottom of the first divider. In still other examples, the middle length of the first divider is the same length as the bottom of the first divider but smaller than the length of the top of the first divider. Having a smaller length in the middle of the first divider allows the first divider to be more easily installed in a container with varying widths because it can be installed without touching the inner walls of the container.

In still other examples, the middle of the first divider is the same length as the top and bottom of the first divider. In yet other examples, the length of the middle of the first divider is greater than the length of the top of the first divider and the length of the bottom of the first divider. Having a longer length in the middle of the first divider allows the first divider to be more easily installed in a container with varying widths, such as a container with a wider middle section, because the first divider can be installed without touching the walls of the container.

One embodiment of the invention would have the thickness of the first divider range from 0.25 inches to 2 inches. Along these same lines, one embodiment of the invention would have a first slot in any wall of the container is configured to receive a first divider with a range in thickness from 0.25 inches to 2 inches.

One embodiment of the invention would have the length of the first divider range from 2 inches to 36 inches. Along these same lines, one embodiment of the invention would have the inside width of the container can range from 2 inches to 36 inches.

One embodiment of the invention would have the width of the first divider range from 2 inches to 36 inches. Along these same lines, one embodiment of the invention would have the depth of the container range from 2 inches to 36 inches.

In addition to the container and first divider, at least one example of the method includes providing a container body with a volume defined by a first wall of the container. By way of example, the container can have one wall, two walls, three walls, four walls, or more. The wall or walls form an inside depth, inside length, and inside width. In some examples, the inside width of the container is the same length. In other examples, the inside width of the container varies. In yet other examples, the inside width of the top portion of the container is less than the inside width of the bottom portion of the container. In still other examples, the inside width of the middle portion of the container is greater than the inside width of the other portions of the container.

In addition to the method for providing a container body with a volume defined by a first wall of the container, this disclosure provides a method for forming a first slot in any wall of the container. By way of example, a first slot is in any of the outer walls of the container. In still other examples, a first slot is in the inner walls of the container. In yet other examples, a first slot is in any outer wall and partially in any inner wall of the container. In still other examples, a first slot is less high than the entire height of any inner wall of the container. In yet other examples, a first slot is less high than the entire height of any outer wall of the container. In still other examples, a first slot is the same height as any outer or inner wall of the container.

In addition to the method for forming a first slot in a first wall of the container, this disclosure provides a method for inserting a first divider into a first slot of a first container wall. By way of example, the middle section of the first divider is the same length as the top and bottom of the first divider. In yet other examples, the length of the middle section of the first divider is greater than the top of the first divider and the length of the bottom of the first divider. In still other examples, the length of the middle of the first divider is less than the length of the top of the first divider and less than the length of the bottom of the first divider.

In addition to the method for inserting a first divider into a first slot of a first container wall, this disclosure provides a method for an associate user rotating the first divider on a vertical axis at an angle of 10° to 170° to a first container wall that makes up the length of the container. By way of example, a person holds the first divider with one or two hands so that it is in a vertical position. In some examples, the width of the first divider is equal to or close to equal to the width of the container and the person may lower the first divider into the container at a wider angle so that the first divider does not touch an inside wall of the container. In yet other examples, the width of the first divider is less than the width of the container and the person may lower the first divider into the container at a narrower angle so that the first divider does not touch an inside wall of the container.

In addition to the method for rotating the first divider on a vertical axis, this disclosure provides a method for an associate user configuring the first divider. By way of example, a person is holding the first divider in a vertical position rotated along a vertical axis at an angle to any inside wall that makes up the length of the container, and the person rotates the first divider along the vertical axis so that the first divider is perpendicular to the length of the container and is parallel to the width of the container. In another example, the top portion of the first divider is above a first slot in the container. In yet other examples, the person may configure the first divider further by moving it above a first slot in the container.

In addition to the method for configuring the first divider, this disclosure provides a method for pushing straight down on the first divider. By way of example, a person is holding the first divider in a vertical position above a first slot in the container wall, and the person pushes straight down on the first divider.

In addition to the method for pushing straight down on the first divider, this disclosure provides a method for securing the first divider. By way of example, a person exerts force on the first divider so that the first divider enters a first slot in the container. In one example, the first divider is secured in a first slot of the container by tensioned thickness. In another example, the first divider is secured in a first slot of the container by a hook.

Other benefits and advantages of this invention will become apparent to those skilled in the art to which it pertains upon reading and understanding of the following detailed specification.

### III. BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the invention in sufficient detail to enable one of ordinary skill in the art to which the invention pertains to make and use the invention.

FIG. 1 is an exemplary embodiment of a first divider shown in a front view.

FIG. 2 is an exemplary embodiment of a first divider shown in a back view.

FIG. 3 is an exemplary embodiment of a first divider shown in a side perspective.

FIG. 4 is a perspective view of one exemplary embodiment of a container and a first divider.

FIG. 5 is a perspective view of one exemplary embodiment of a container and a first divider in the bed of a pickup truck.

FIG. 6 illustrates four steps of an exemplary method for fabricating a container.

FIG. 7 is a top blown-up view of one exemplary embodiment of a first divider in a slot.

### IV. DETAILED DESCRIPTION

The present disclosure overcomes the foregoing and other shortcomings and drawbacks of toolbox dividers that are difficult to install and rattle while driving. The present invention extends to apparatus and methods for a first divider and container. Such are configured to, for example, allow a skilled artisan to create a first divider and container for easy installation and no rattling.

Referring now to the drawings wherein the showings are for purposes of illustrating embodiments of the article only and not for purposes of limiting the same, and wherein like reference numerals are understood to refer to like components:

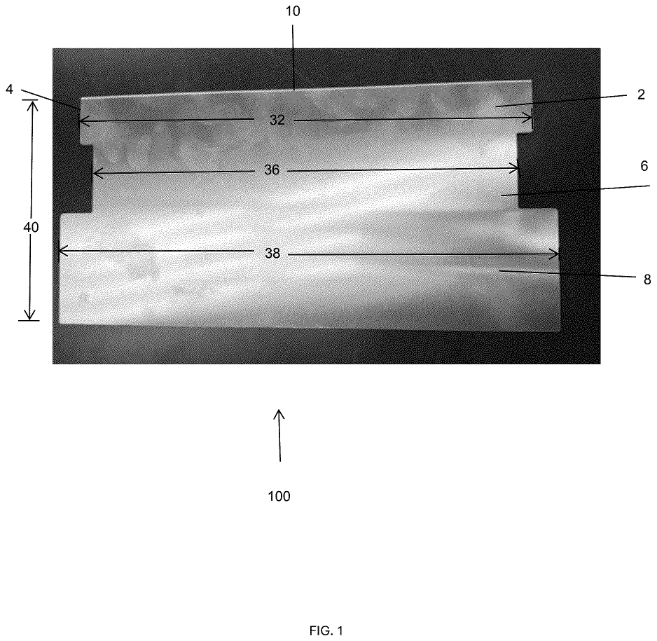

FIG. 1 illustrates the front of an exemplary embodiment of the first divider 100. As shown in in FIG. 1, the first divider 100 has a width 40. The width 40 can range from 2 inches to 36 inches. The first divider 100 also contains sections 2, 6, and 8. Section 2 has a length 32. Section 6 has a length 36. Section 8 has a length 38. Lengths 32, 36, and 38 may be different as depicted in FIG. 1. Length 38 can range from 2 inches to 36 inches. The first divider 100 has a fold 10 that is folded into a fourth section 4 on the other side of section 2 behind the first divider 100. Sections 2 and 4 may be the same length.

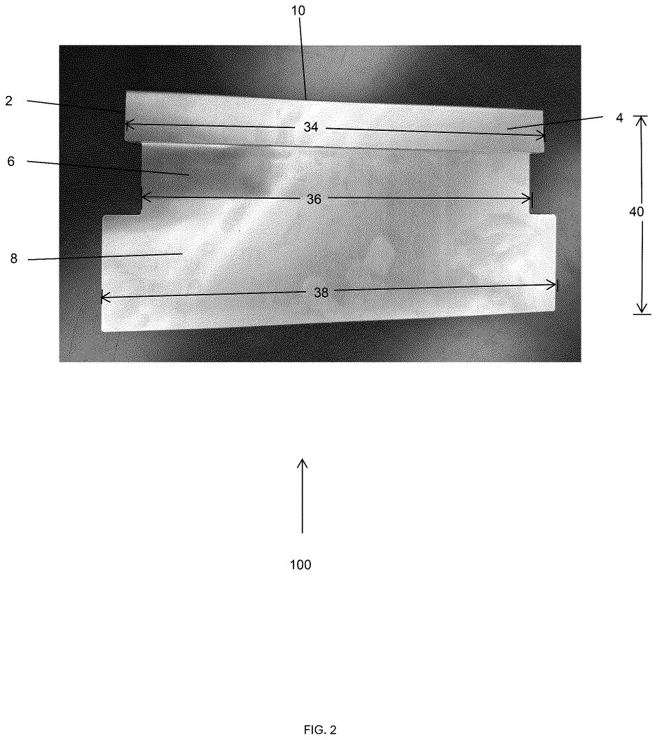

FIG. 2 illustrates the back of an exemplary embodiment of the first divider 100. As shown in in FIG. 2, the first divider 100 has a width 40. The first divider 100 contains sections 4, 6, and 8. Section 4 has a length 34. Section 6 has a length 36. Section 8 has a length 38. FIG. 2 illustrates lengths 34, 36, and 38 may be different. FIG. 2 illustrates the fold 10 of the first divider 100 and the section 4 folded behind the first divider 100 with section 2 being on the other side of section 4. Section 2 with length 32 and section 4 with length 34 may be the same length as illustrated.

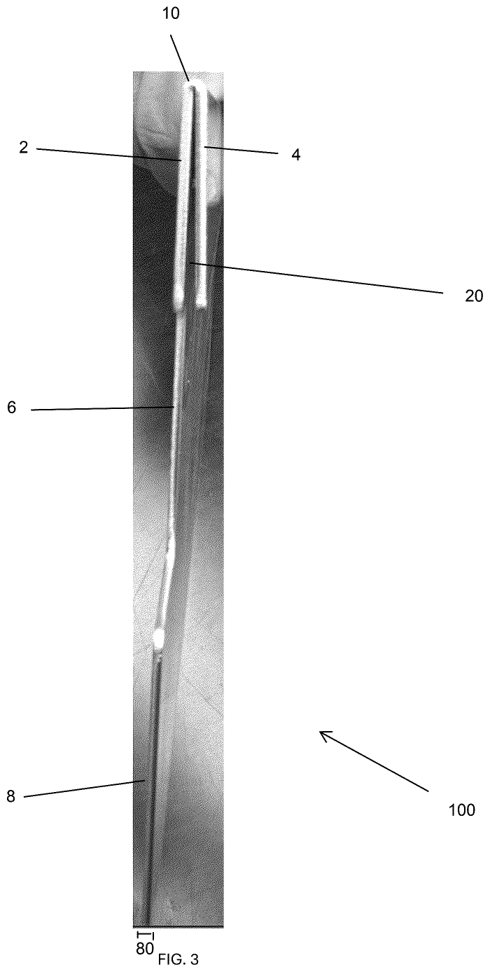

FIG. 3 illustrates the side view of an exemplary embodiment of the first divider 100. One embodiment of the first divider 100 contains sections 2, 4, 6, and 8. Sections 2, 6, and 8 are on the front of the first divider 100. FIG. 3 illustrates the fold 10 between Section 4 folded behind section 2. Sections 2 and 4 may be the same length as illustrated. FIG. 3 also shows a distance 20 between section 2 and section 4 of the first divider 100. The distance 20 between section 2 and section 4 of the first divider 100 can range from 0.01 inches to 0.25 inches. FIG. 3 also shows a thickness 80. The thickness 80 can range from 0.25 inches to 2 inches.

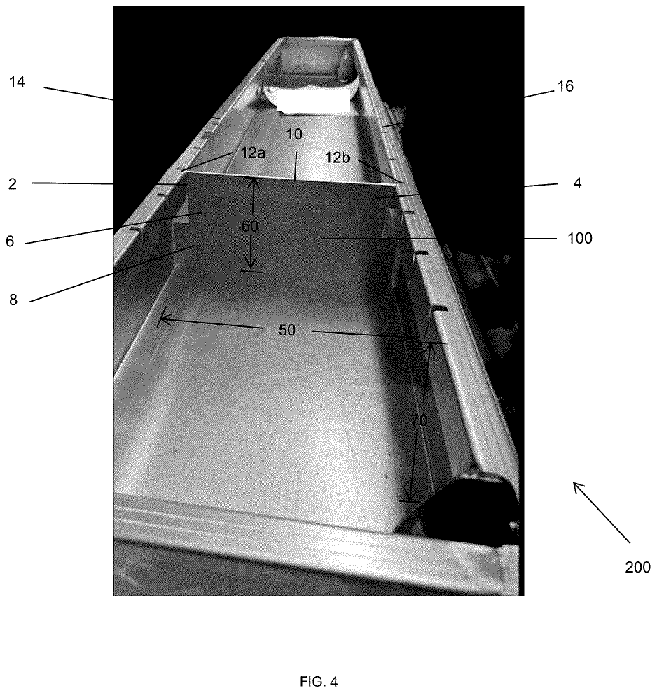

FIG. 4 illustrates a perspective view of an exemplary embodiment of a first divider 100 in a container 200. One embodiment of the container 200 contains walls 14 and 16 that form an inner width 50. The container 200 also contains slots 12a and 12b. Sections 4 of the first divider 100 is folded behind section 2 and with a fold 10. Together sections 2 and 4 of the first divider 100 are secured into slots 12a and 12b of the container 200. The container 200 has an inner depth 70. The first divider 100 has a height 60. The inner width 50, the height 60, and inner depth 70 may each range from 2 inches to 36 inches

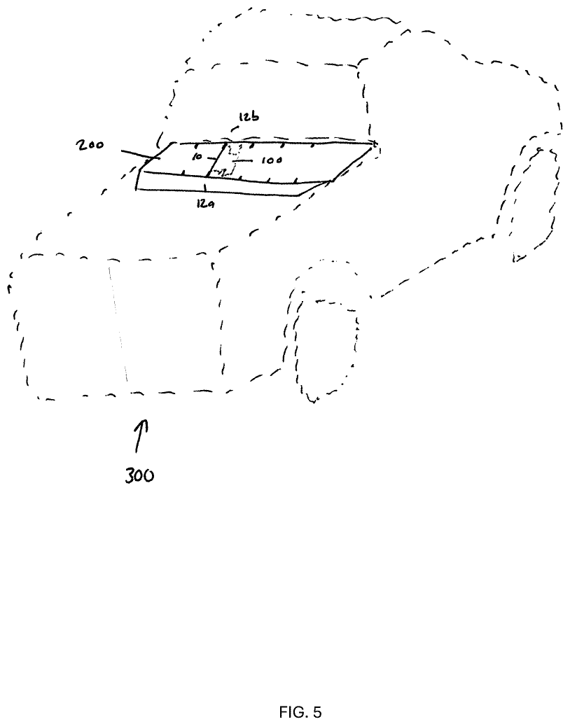

FIG. 5 illustrates a perspective view of one exemplary embodiment of a container 200 and first divider 100 in the bed of a pickup truck 300. The first divider 100 is secured in slots 12a and 12b of the container 200 at the fold 10 of the first divider 100.

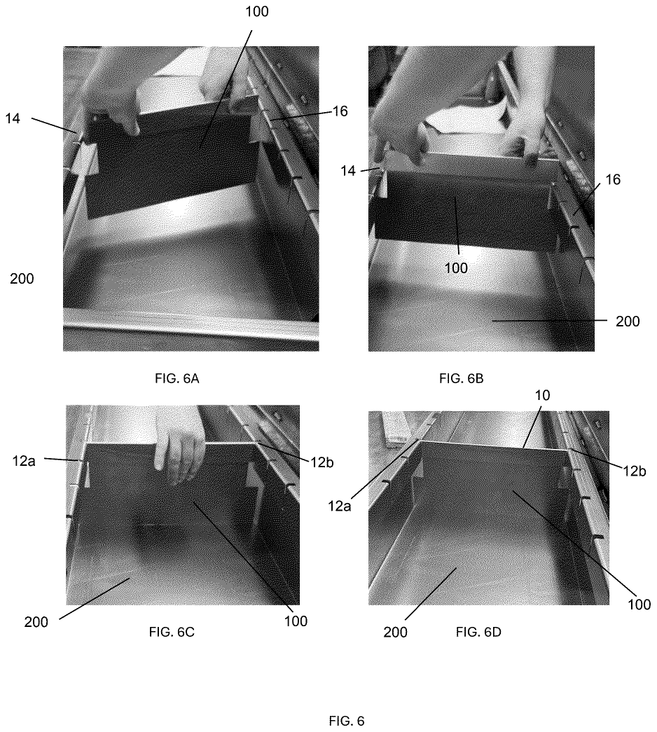

FIG. 6 illustrates four steps of an exemplary method for fabricating a container. FIG. 6A illustrates the first divider 100 at a rotated angle to the side walls 14 and 16 of the container 200. FIG. 6B illustrates the first divider 100 perpendicular to the side walls 14 and 16 of the container 200. FIG. 6C illustrates the first divider 100 over slots 12a and 12b in the container 200. FIG. 6D illustrates the first divider 100 secured in slots 12a and 12b of the container 200 at the fold 10 of the first divider 100. Each of these four illustrative steps may be employed to fabricate a container.

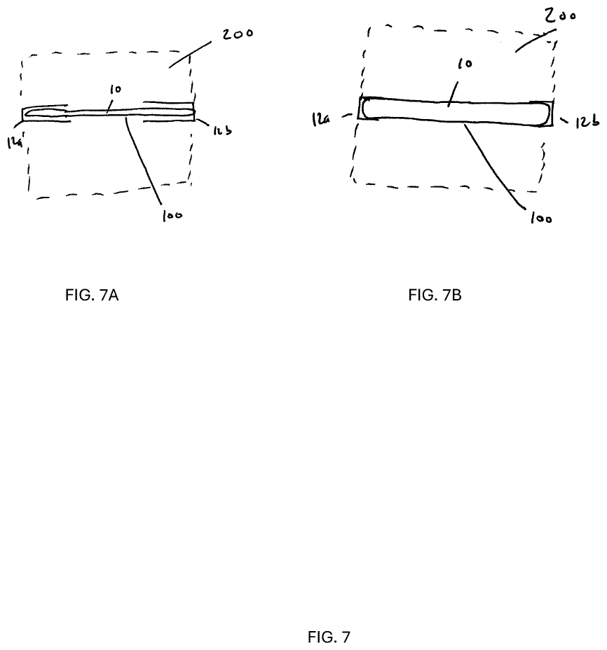

FIG. 7 shows a top blown-up view of one exemplary embodiment of a first divider in a slot. FIG. 7A shows the first divider 100 in slots 12a and 12b of a container 200 as the first divider 100 is being pressed down into the slots 12a and 12b moments before the first divider 100 secures. FIG. 7A shows fold 10 of the first divider 100 is compressed and does not completely fill slots 12a and 12b. FIG. 7B shows the first divider 100 secured in slots 12a and 12b of a container 200. The fold 10 is expanded and completely fills slots 12a and 12b.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A container for selectively mounting on an associated vehicle, said container, comprising:
a first wall, said container having an associated volume defined by said first wall of said container;
a first slot formed in said first wall; and
a first divider configured to be selectively received into said first slot.

2. The container of claim 1 wherein said container is comprised of a rigid material, said rigid material comprising one or more materials selected from a group comprising metal, steel, stainless steel, aluminum, cardboard, plastic, wood, or combinations thereof.

3. The container of claim 1 wherein said first divider further comprises:
a first section with a first section length; and
a second section folded behind said first section configured to provide adjustable tension for an interference fit with said first slot in said first wall of said container.

4. The container of claim 3 further comprising a distance between said first section and said second section ranging from 0.01 inches to 0.25 inches.

5. The container of claim 3 wherein said first divider further comprises a third section with a third section length.

6. The container of claim 5 wherein said third section length is less than said first section length.

7. The container of claim 5 wherein said first divider further comprises a fourth section with a fourth section length.

8. The container of claim 7 wherein said fourth section length is less than said third section length and less than said first section length.

9. The container of claim 1 wherein said first divider ranges in thickness from 0.25 inches to 2 inches.

10. The container of claim 1 wherein said first divider comprises a width that ranges from 2 inches to 36 inches.

11. The container of claim 7 wherein said fourth section length ranges from 2 inches to 36 inches.

12. A first divider of rigid material wherein said rigid material comprises one or more materials selected from a group comprising metal, steel, stainless steel, aluminum, cardboard, plastic, wood, or combinations thereof, comprising:
a first section with a first section length;
a second section with a second section length that is folded behind said first section, and configured to provide adjustable tension for an interference fit with a first slot in a first wall of a container;
a distance between said first section and said second section ranging from 0.01 inches to 0.25 inches;
a third section with a third section length wherein said third section length is less than said first section length and said second section length; and
a fourth section with a fourth section length wherein said fourth section length is greater than said first section length, said second section length, and said third section length.

13. A method for fabricating a container, comprising the steps of:
providing a container body with a volume defined by a first wall of said container;
forming a first slot in said first wall of said container; and
inserting a first divider comprising a first section with a first length and a second section with a second length that is folded behind said first section configured to provide adjustable tension for an interference fit between said first divider and said first slot in said first wall of said container.

14. The method of claim 13, wherein said first divider further comprises a third section with a third length, and a fourth section with a fourth length.

15. The method of claim 14, wherein said first length and said second length of the first divider are equal, and wherein said first length, said third length, and said fourth length are not equal.

16. The method of claim 15, wherein said first length is greater than said third length, and said third length is less than said fourth length.

17. The method of claim 16, wherein an associated user may rotate said first divider on an associated vertical axis at an angle from an associated group ranging from 10° to 170° to said first wall of said container.

18. The method of claim 16, further comprising the step of the associated user configuring said first divider so that it is perpendicular to said first wall of said container, and said first section and said second section are directly above said first slot in said first wall of said container.

19. The method of claim 16, further comprising the step of the associated user pushing straight down on said first divider.

20. The method of claim 16, further comprising the step of securing said first section and said second section into said first slot in said first wall of said container.
